(19) United States
(12) Patent Application Publication
(10) Pub. No.: US 2019/0194084 A1
(43) Pub. Date: Jun. 27, 2019

(54) SOLUBLE GRANULAR FERTILIZER FOR FERTIGATION

(71) Applicant: SABIC GLOBAL TECHNOLOGIES B.V., BERGEN OP ZOOM (NL)

(72) Inventor: MOHAMED AKASHA KHALEEL, Riyadh (SA)

(21) Appl. No.: 16/328,534

(22) PCT Filed: Aug. 28, 2017
(86) PCT No.: PCT/IB2017/055158

§ 371 Date: Feb. 26, 2019

Related U.S. Application Data
(60) Provisional application No. 62/380,535, filed on Aug. 29, 2016.

(51) Int. Cl. C05G 3/00; C05B 1/00; C05B 7/00; C05C 11/00; C05D 1/00

(52) U.S. Cl. CPC C05G 3/0041; C05B 1/00; C05D 1/00; C05C 11/00; C05B 7/00

(57) ABSTRACT

Disclosed herein is a fertilizer composition including a plant nutrient comprising a phosphorus compound; and an inorganic acidic compound free of phosphorus. The fertiliser composition can also comprise a fertilizer granule and a coating disposed on the fertilizer granule wherein the fertilizer granule comprises a plant nutrient; and the coating comprises sulfuric acid, nitric acid, hydrochloric acid, or a combination. The plant nutrient comprises a phosphorus compound. The fertilizer composition is useful in fertigation.

### BACKGROUND

This disclosure is directed to granular fertilizers, their methods of manufacture, and methods of use.

Fertigation is defined as using fertilizer with irrigation water in a single process. Fertigation has become increasingly important in modern agriculture. Fertigation can save 20% or more of the water used for irrigation during a crop life cycle. In addition it increases fertilizer efficiency and nutrient uptake by the crop.

The advantages of fertigation over conventional practices are well recognized. The cost and availability of fertilizers that can be used for fertigation is a limiting factor to the expansion of fertigation. Fertilizers for fertigation must be water soluble. On average, the cost of a water soluble fertilizer is three to four times the cost of regular solid granular fertilizer. Regular solid granular fertilizer is not readily water soluble and takes a long time until it is converted into soluble material after being directly applied to the soil.

Accordingly, there is a need in the art for water soluble fertilizer compositions and methods of making them.

### SUMMARY

Disclosed herein is a fertilizer composition, comprising a plant nutrient and an inorganic acidic compound free of phosphorus. In addition, the plant nutrient can include nitrogen compounds, potassium compounds, additional nutrient compounds, trace elements and combinations thereof.

Also described herein is a method of fertigation, comprising combining a fertilizer composition with water to form a fertigation solution having a pH less than or equal to 6, wherein the fertilizer composition comprises a plant nutrient and an inorganic acidic compound free of phosphorus; and applying the fertigation solution to a crop. The plant nutrient comprises a phosphorus compound. In addition, the plant nutrient can include nitrogen compounds, potassium compounds, additional nutrient compounds, trace elements, and combinations thereof.

Also described herein is a fertilizer composition comprising: a fertilizer granule and a coating disposed on the fertilizer granule wherein the fertilizer granule comprises a plant nutrient; and the coating comprises sulfuric acid, nitric acid, hydrochloric acid, or a combination comprising at least one of the foregoing, and further wherein the plant nutrient comprises a phosphorus compound. In addition, the plant nutrient can include nitrogen compounds, potassium compounds, additional nutrient compounds, trace elements, and combinations thereof.

The above described and other features are further set forth in the following figures, detailed description, and claims.

### DETAILED DESCRIPTION

As described above there is an increasing need for water soluble fertilizers for use in fertigation. Granular fertilizers for direct application to soil typically comprise phosphate. When these fertilizers are combined with water, phosphate ions can combine with positive ions present in the water or in the fertilizer and compounds such as calcium phosphate or/and magnesium phosphate can form. These compounds can have minimal solubility in water, particularly at a pH greater than or equal to 7, causing the fertilizer to have minimal solubility in irrigation situations. This phenomenon occurs regardless of the source of phosphate ions or the source of other major components of the fertilizer such as the potassium compound or the nitrogen compound.

Granular fertilizer that can be directly applied to the soil can be modified for use in fertigation through the addition of an inorganic acidic compound free of phosphorus. In some embodiments the inorganic compound is included in a coating applied to the granular fertilizer. As used herein the term “acidic compound” refers to an acidic compound having a pKa less than or equal to 2. Without being bound by theory, it is believed that when the fertilizer granule having an inorganic acidic compound is combined with water the acidic compound lowers the pH of the water and minimizes or prevents the formation of compounds with reduced water solubility such as calcium phosphate. As appreciated by one of skill in the art the use of an inorganic acidic compound will minimize or prevent the formation of compounds with reduced water solubility regardless of the exact composition of the fertilizer composition or the source of the plant nutrients in the fertilizer composition. Accordingly, the concepts disclosed herein are not limited to NPK fertilizer compositions, or the NPK grades disclosed herein. Rather, the use of inorganic acidic compound is applicable to any fertilizer composition that comprises phosphorus.

The fertilizer composition comprises a plant nutrient. The plant nutrient comprises a phosphorus compound. In addition, the plant nutrient can include nitrogen compounds, potassium compounds, additional nutrient compounds, trace elements and combinations thereof. In some embodiments the fertilizer composition comprises a nitrogen compound and a phosphorus compound. Exemplary nitrogen compounds include ammonium nitrate, ammonium sulfate, ammonium sulfate nitrate, calcium nitrate, calcium ammonium nitrate, urea, urea-formaldehyde or a combination comprising at least one of the foregoing. Exemplary phosphate compounds include monoammonium phosphate (“MAP”), diammonium phosphate (“DAP”), polyphosphate compounds including but not limited to P₂O₅, phosphate rock, single superphosphate (“SSP”), triple super phosphate (“TSP”), or a combination thereof.

In some embodiments, the fertilizer composition comprises urea.

The amounts of nitrogen and phosphorus compounds included in the final fertilizer granules depends on the intended end use, and can be 1 to 60 wt. % for each component, based on the total weight of the fertilizer composition. Amounts of nitrogen, phosphorus and optional potassium are expressed in weight percent assuming that the phosphorus is present as P₂O₅, the nitrogen is present as elemental nitrogen and the optional potassium is present as K₂O. This is the convention in the art of fertilizers and is regardless of the actual source of phosphorus, nitrogen, or potassium. Thus, an NPK fertilizer composition can be expressed using the convention X:Y:Z, where X is the percent by weight of elemental N in the fertilizer composition, Y is the weight percent of P (assuming all is present as P2O5) in the composition, and Z is the weight percent of K (assuming all is present as K2O0) in the composition. This convention is used herein unless otherwise specified. This convention is used and is applicable regardless of the actual N, P or K source.

Exemplary potassium sources include potassium nitrate, potassium chloride, or potassium sulfate (“SOP” or potash). Combinations thereof may also be used.

The fertilizer composition can comprise an additional nutrient compound. Additional nutrient compounds include magnesium compounds. An exemplary magnesium compound is magnesium sulfate. The amount of each additional nutrient compound depends on the intended end use and can be, for example, 0.1 to 50 wt. %, based on the total weight of the fertilizer composition.

In some embodiments the fertilizer composition comprises a nitrogen compound, a phosphorus compound and a potassium compound.

Additionally a source of one or more trace elements, i.e., micronutrients, can be included, for example boron, calcium, chlorine, cobalt, copper, iron, manganese, molybdenum, sodium, zinc, or a combination thereof can be present. These nutrients may be supplied in elemental form, as an oxide, or in the form of salts, for examples as sulfates, nitrates, or halides. The amount of plant micronutrients depends on the intended end use and can be, for example, 0.1 to 5 wt. %, based on the total weight of the fertilizer composition.

The fertilizer composition comprises an inorganic acidic compound free of phosphorus. The acidic compound has a pKa less than or equal to 2, or, more specifically, a pKa less than or equal to 0, or, more specifically, less than or equal to -2. Exemplary acidic compounds include sulfuric acid, nitric acid, hydrochloric acid, or a combination thereof. The inorganic acidic compound is present in an amount of 0.1 to 2 wt %, or, 0.1 to 5 wt %, or 0.1 to 10 wt %, based on the total weight of the fertilizer composition.

Fillers can further be present in the composition, for example bentonite, calcite, calcium oxide, calcium sulfate (anhydrous or hemihydrate), dolomite, talc, sand, or a combination comprising at least one of the foregoing fillers.

Other components of granular fertilizers can include, for example, surfactants, nucleation agents, or recycled fertilizer particles, which can act as a source of agents, nucleating soil conditioners such as calcium carbonate, activated carbon, elemental sulfur, biocides such as pesticides, herbicides, or fungicides, wicking agents, wetting agents, heat stabilizers, adhesives such as cellulose, polyvinyl alcohols, fats, oils, gum arabics, vinylidene ultraviolet stabilizers, antioxidants, reducing agents, colorants, binders (i.e., organochlorides, zeins, gelatins, chitosan, polyethylene oxide polymers, and acrylamide polymers and copolymers), and the like.

The fertilizer composition is granular and the granules can have any shape or size suitable for their intended use. In some embodiments the fertilizer granules are substantially spherical. The fertilizer granules have an average particle diameter of 1.0 to 4.0 or 1.0 to 5.0 millimeters (mm). Within this range the average particle diameter can be greater than or equal to 1.5, or greater than or equal to 2.0 mm. Also within this range the average particle diameter can be less than or equal to 3.5, or less than or equal to 3.0 mm. In an embodiment at least 90% by weight of the fertilizer granules have a particle diameter of 2.0 to 4.0 mm. Particle diameter is determined according to “Size Analysis—Sieve Method” IFDC S-107 issued by International Fertilizer Development Center (IFDC) which is the most common and internationally approved method used to determine fertilizer particle size.

In some embodiments the inorganic acidic compound is part of a coating disposed on at least a portion of the surface of the granular fertilizer.

The coating comprises the inorganic acidic compound in an amount of 75 to 100 wt. % based on the total weight of the coating. Within this range the acidic compound can be present in an amount greater than or equal to 80 wt. %, or, greater than or equal to 90 wt. %.

The coating can optionally comprise up to 25 wt. % of additives, based on the total weight of the coating. Exemplary additives include poly(lactic acid), poly(butylene succinate), cellulose acetate, lignin, an adjuvant, or a combination thereof. Exemplary adjuvants include colorants, an adhesion promoters, surfactants, or a combination comprising at least one of the foregoing, provided that the adjuvant does not significantly adversely affect the desired properties of the coated fertilizer. For example, a surfactant can include a primary and secondary (C₁₆₋₃₀)alkylamine, a (C₁₆₋₃₀)fatty acid amide of a primary (C₁₆₋₃₀)alkylamine, or a (C₁₆₋₃₀)fatty acid ester of a (C₁₆₋₃₀)alkanol. Examples of the foregoing surfactants include cetyl amine, stearyl amine, arachidyl amine, behenyl amine, dicetyl amine, distearyl amine, diarachidyl amine, dibehenyl amine, di(hydrogenated tallow) amine, cetyl stearamide, stearyl stearamide, stearyl erucamide, erucyl erucamide, candililla wax, carnauba wax, and montan wax.

When coated on the fertilizer granules, the amount of the coating (including the optional additives) is less than or equal to 6 wt. %, for example, 0.1 to 6 wt. %, 0.5 to 5 wt. %, 2 to 5 wt. %, or 3 to 5 wt. %, based on the total weight of the coated fertilizer.

The coated fertilizer can be manufactured by various methods. The fertilizer granules can be coated by spray coating (for example, top, bottom, or side spray coating), drum coating, pan coating, fluid bed coating, continuous pour coating, or any other method known to those of skill in the art. This coating can be done in a batch or in a continuous process. The granules can be coated with a single layer in a single coating application, or the granules can be coated with multiple layers of the same coating material, such as, 2, 3, 4, 5, or more layers.

In a specific embodiment, a method of manufacturing comprises spraying a coating composition comprising a concentrated acid solution during granulation inside the granulation drum or pan. A concentrated acid solution is defined as being greater than or equal to a 6 Molar solution.

It is also contemplated that the fertilizer composition comprising the inorganic acidic compound can be blended with a granular fertilizer free of inorganic acidic compound. In such a situation the fertilizer composition comprising the inorganic acidic compound is present in an amount sufficient to result in a fertigation solution with a pH less than 6 when combined with water.

In use, the fertilizer composition is combined with water to form a fertigation solution having a pH less than or equal to 5, wherein the fertilizer composition is described above. The fertilizer compositions is dissolved in water and the resulting fertigation solution has less than or equal to 5 wt. % undissolved solids, or less than or equal to 2 wt. % undissolved solids, or less than or equal to 1 wt. % undissolved solids, based on the total weight of the fertigation solution. The fertigation solution is then applied to the crop, more specifically, applied to the crop in combination with irrigation.

The water soluble fertilizers for fertigation are further illustrated by the following non-limiting examples.

### EXAMPLES

### Example 1

Material A: 20 grams of grade 14:38:10 fertilizer was placed in a beaker and stirred with 100 milliliters (ml) of irrigation water having a pH of 7.8. Material B: 20 grams of 14:38:10 fertilizer coated with 98% concentrated sulfuric acid was placed in a beaker and stirred with 100 ml irrigation water having a pH 7.8. Both containers were stirred for approximately 2 minutes. The Material A remained undissolved and Material B completely dissolved in the high pH irrigation water. After Material B was dissolved the pH of the solution was 4.08.

### Example 2

Material A: 20 grams of grade 11:29:19 fertilizer was placed in a beaker and stirred with 100 ml irrigation water having a pH of 7.8. Material B: 20 grams of grade 11:29:19 fertilizer coated with 98% concentrated sulfuric acid was placed in a beaker stirred with 100 ml irrigation water having a pH of 7.8. Both containers were stirred for approximately 2 minutes. Material A remained undissolved and Material B completely dissolved in the high pH irrigation water. After Material B was dissolved the pH of the solution was 4.25.

### Example 3

Material A: 20 grams of grade 11:52:0 fertilizer was placed in a beaker and stirred with 100 ml irrigation water having a pH of 7.8. Material B: 20 grams of grade 11:52:0 fertilizer coated with 98% concentrated sulfuric acid was placed in a beaker stirred with 100 ml irrigation water having a pH of 7.8. Both containers were stirred for approximately 2 minutes. Material A remained undissolved and Material B completely dissolved in the high pH irrigation water. After Material B was dissolved the pH of the solution was 4.02.

### Example 4

Material A: 20 grams of grade 18:46:0 fertilizer was placed in a beaker and stirred with 100 ml irrigation water having a pH of 7.8. Material B: 20 grams of grade 18:46:0 fertilizer coated with 98% concentrated sulfuric acid was placed in a beaker stirred with 100 ml irrigation water having a pH of 7.8. Both containers were stirred for approximately 2 minutes. Material A remained undissolved and Material B completely dissolved in the high pH irrigation water. After Material B was dissolved the pH of the solution was 4.85.

### Example 5

Material A: 20 grams of grade 28:28:0 fertilizer was placed in a beaker and stirred with 100 ml irrigation water having a pH of 7.8. Material B: 20 grams of grade 28:28:0 fertilizer coated with 98% concentrated sulfuric acid was placed in a beaker stirred with 100 ml irrigation water having a pH of 7.8. Both containers were stirred for approximately 2 minutes. Material A remained undissolved and Material B completely dissolved in the high pH irrigation water. After Material B was dissolved the pH of the solution was 5.05.

As can be seen by the foregoing examples the presence an inorganic acid resulted in the complete dissolution of fertilizer composition in water whereas the fertilizer without an acid did not dissolve. The presence of the acid facilitates the dissolution of the fertilizer composition in water, thus making use of the fertilizer in fertigation applications possible.

Embodiment 1: A fertilizer composition, comprising: a plant nutrient; and an inorganic acidic compound free of phosphorus, wherein the plant nutrient comprises a phosphorus compound.

Embodiment 2: The composition of Embodiment 1, wherein the plant nutrient further comprises a nitrogen compound, a potassium compound, an additional nutrient compound, trace element, or a combination thereof.

Embodiment 3: The composition of Embodiment 2, wherein the additional nutrient compound comprises a magnesium compound.

Embodiment 4: The composition of any one of the preceding Embodiments, wherein the plant nutrient comprises a combination of a nitrogen compound, a phosphorus compound and a potassium compound.

Embodiment 5: The composition of any one of the preceding Embodiments, wherein the inorganic acidic compound has a pKa less than 2, less than 1, less than 0, less than −1 or less than −2.

Embodiment 6: The composition of any one of the preceding Embodiments, wherein the inorganic acidic compound comprises sulfuric acid, hydrochloric acid, nitric acid or a combination comprising at least one of the foregoing.

Embodiment 7: The composition of any one of the preceding Embodiments, wherein inorganic acidic compound is part of a coating and the coating comprises 75 to 100 wt. % of the inorganic acidic compound and 0.0 to 25 wt. % of an additive, based on the total weight of the coating.

Embodiment 8: The composition of any one of the preceding Embodiments, wherein the composition comprises 0.2 to 5 weight percent of the inorganic acidic compound free of phosphorus based on the total weight of the fertilizer compound.

Embodiment 9: A method of fertigation, comprising: combining a fertilizer composition with water to form a fertigation solution having a pH less than or equal to 6, wherein the fertilizer composition comprises an inorganic acidic compound free of phosphorus and a plant nutrient comprising a phosphorus compound; and applying the fertigation solution to a crop.

Embodiment 10: The method of Embodiment 9, wherein the plant nutrient further comprises a nitrogen compound, a potassium compound, an additional nutrient compound, trace element, or a combination thereof

Embodiment 11: The method of Embodiment 10, wherein the additional nutrient compound comprises a magnesium compound.

Embodiment 12: The method of any one of Embodiments 9 to 11, wherein the plant nutrient comprises a combination of a nitrogen compound, a phosphorus compound and a potassium compound.

Embodiment 13: The method of any one of Embodiments 9 to 12, wherein the inorganic acidic compound has a pKa less than or equal to 0.

Embodiment 14: The method of any one of Embodiments 9 to 13, wherein the inorganic acidic compound comprises sulfuric acid, hydrochloric acid, nitric acid, or a combination comprising at least one of the foregoing.

Embodiment 15: The method of any one of Embodiments 9 to 14, wherein the inorganic acidic compound is part of a coating and the coating comprises 75 to 100 wt. % of the inorganic acidic compound and 0.0 to 25 wt. % of an additive, based on the total weight of the coating.

Embodiment 16: The method of any one of Embodiments 9 to 15, wherein the composition comprises 0.2 to 5 weight percent of the inorganic acidic compound free of phosphorus based on the total weight of the fertilizer compound.

Embodiment 17: A fertilizer composition comprising: a fertilizer granule and a coating disposed on the fertilizer granule wherein the fertilizer granule comprises a plant nutrient; and the coating comprises sulfuric acid, nitric acid, hydrochloric acid, or a combination comprising at least one of the foregoing.

Embodiment 18: The fertilizer composition of Embodiment 17, wherein the plant nutrient comprises a combination of a nitrogen compound, a phosphorus compound, and a potassium compound.

Embodiment 19: The fertilizer composition of Embodiment 17 or 18, wherein the coating comprises sulfuric acid.

Embodiment 20: The composition of any one of Embodiments 17 to 19, wherein the coating comprises 75 to 100 wt. % of the acidic compound and 0.0 to 25 wt. % of an additive, based on the total weight of the coating.

The singular forms “a,” “an,” and “the” include plural referents unless the context clearly dictates otherwise. “Or” means “and/or.” The endpoints of all ranges directed to the same component or property are inclusive and independently combinable. The suffix “(s)” as used herein is intended to include both the singular and the plural of the term that it modifies, thereby including at least one of that term (e.g., “colorant(s)” includes at least one colorant). “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs.

As used herein, a “combination” is inclusive of blends, mixtures, alloys, reaction products, and the like. Compounds are described using standard nomenclature.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A fertilizer composition, comprising:
a plant nutrient comprising a phosphorus compound; and an inorganic acidic compound free of phosphorus.

2. The composition of claim 1, wherein the plant nutrient comprises a nitrogen compound, a potassium compound, an additional nutrient compound, trace element, or a combination thereof

3. The composition of claim 2, wherein the additional nutrient compound comprises a magnesium compound.

4. The composition of claim 1, wherein the plant nutrient comprises a combination of a nitrogen compound, a phosphorus compound and a potassium compound.

5. The composition of claim 1, wherein the inorganic acidic compound has a pKa less than 0.

6. The composition of claim 1, wherein the inorganic acidic compound comprises sulfuric acid, hydrochloric acid, nitric acid or a combination comprising at least one of the foregoing.

7. The composition of claim 1, wherein inorganic acidic compound is part of a coating and the coating comprises 75 to 100 wt. % of the inorganic acidic compound and 0.0 to 25 wt. % of an additive, based on the total weight of the coating.

8. The composition of claim 1, wherein the composition comprises 0.2 to 5 weight percent of the inorganic acidic compound free of phosphorus based on the total weight of the fertilizer compound.

9. A method of fertigation, comprising:
combining a fertilizer composition with water to form a fertigation solution having a pH less than or equal to 6, wherein the fertilizer composition comprises an inorganic acidic compound free of phosphorus and a plant nutrient comprising a phosphorus compound; and
applying the fertigation solution to a crop.

10. The method of claim 9, wherein the plant nutrient further comprises a nitrogen compound, a potassium compound, an additional nutrient compound, trace element, or a combination thereof

11. The method of claim 10, wherein the additional nutrient compound comprises a magnesium compound.

12. The method of claim 9, wherein the plant nutrient comprises a combination of a nitrogen compound, a phosphorus compound and a potassium compound.

13. The method of claim 9, wherein the inorganic acidic compound has a pKa less than or equal to 0.

14. The method of claim 9, wherein the inorganic acidic compound comprises sulfuric acid, hydrochloric acid, nitric acid, or a combination comprising at least one of the foregoing.

15. The method of claim 9, wherein the inorganic acidic compound is part of a coating and the coating comprises 75 to 100 wt. % of the inorganic acidic compound and 0.0 to 25 wt. % of an additive, based on the total weight of the coating.

16. The method of claim 9, wherein the composition comprises 0.2 to 5 weight percent of the inorganic acidic compound free of phosphorus based on the total weight of the fertilizer compound.

17. A fertilizer composition comprising: a fertilizer granule and a coating disposed on the fertilizer granule wherein the fertilizer granule comprises a plant nutrient; and the coating comprises sulfuric acid, nitric acid, hydrochloric acid, or a combination comprising at least one of the foregoing.

18. The fertilizer composition of claim 17, wherein the plant nutrient comprises a combination of a nitrogen compound, a phosphorus compound, and a potassium compound.

19. The fertilizer composition of claim 17, wherein the coating comprises sulfuric acid.

20. The fertilizer composition of claim 17, wherein the coating comprises 75 to 100 wt. % of the acidic compound and 0.0 to 25 wt. % of an additive, based on the total weight of the coating.
